(19) United States
(12) Patent Application Publication
(10) Pub. No.: US 2006/0191647 A1
(43) Pub. Date: Aug. 31, 2006

(54) Overhead door bracket

(76) Inventor: Dale J. Schulze, Maria Stein, OH (US)

Correspondence Address: LITMAN LAW OFFICES, LTD, PO BOX 15035, CRYSTAL CITY STATION, ARLINGTON, VA, 22215, US

(21) Appl. No.: 11/065,028

(22) Filed: Feb. 25, 2005

(51) Int. Cl. E05D 15/16

(52) U.S. Cl. 160/201

(57) ABSTRACT

An overhead door bracket for attachment of the main arm of an overhead door opener to a metal overhead door for the purpose of opening and closing the door. The inventive bracket has a relatively wide mounting plate which spans the distance between the portions of the sheet metal doors having existing reinforcing backing strips for mounting of the hinges connecting the metal panels of the door. The inventive bracket has conventional connecting tabs spaced and extending outward to receive the lower end of the main arm of an opening system. The tabs have pin receiver bores for pivotally securing the main arm to the bracket by means of a pin. The bracket mounting plate has three spaced rows of mounting holes for mounting the bracket to the upper panel of a hinged door panel, the mounting holes being proximate the respective ends of the bracket.

### BACKGROUND OF THE INVENTION

1. Field of the Invention

The present invention relates to overhead door opening system. More particularly, the present invention relates to center brackets for attachment of the upper end portion of a metal overhead door to an opening system.

2. Description of the Related Art

The design of hinged-panel overhead doors is well known. Power operated door opening systems are popular and share a number of common features. Among these features is a main arm which attaches to a truck mounted on a track operated by a motor. The lower end of the arm is attached to the central upper portion of the door by means of a bracket mounted on the inside face of the door. Existing brackets have a relatively small mounting flange for mounting on wooden doors by means of screws. Existing brackets attached to sheet metal doors by screws are subject to separation from the door panels due to the thin, unsupported nature of the sheet metal. It would be desirable to provide a bracket which may be firmly attached to a sheet metal door with self-threading screws, avoiding the use of special attaching hardware such as throughbolts which require extra time to install and are unsightly. It would also be desirable to provide such a bracket which may be made in differing sizes for applications ranging from garage doors to industrial size overhead doors.

None of the above inventions and patents, taken either singly or in combination, is seen to describe the instant invention as claimed. Thus, a garage door bracket solving the aforementioned problems is desired.

### SUMMARY OF THE INVENTION

The overhead door bracket of the present invention is a bracket for attachment of a main arm of an overhead door opener to a metal overhead door for the purpose of opening and closing the door. The inventive bracket has a relatively wide mounting plate which spans the distance between the portions of the sheet metal doors having existing reinforcing backing strips for mounting of the hinges connecting the metal panels of the door. The inventive bracket has conventional connecting tabs spaced and extending outward to receive the lower end of the main arm of an opening system. The tabs have pin receiver bores for pivotally securing the main arm to the bracket by means of a pin. The bracket mounting plate has three spaced rows of mounting holes for mounting the bracket to the upper panel of a hinged door panel, the mounting holes being proximate the respective ends of the bracket.

These and other features of the present invention will become readily apparent upon further review of the following specification and drawings.

### BRIEF DESCRIPTION OF THE DRAWINGS

FIG. 1 is an environmental, perspective view of an overhead door bracket according to the present invention.

FIG. 2 is an environmental, sectional view of the overhead door bracket installation of FIG. 1 taken along lines 2-2 of FIG. 1.

FIG. 3 is a perspective view of one embodiment of the overhead door bracket of FIG. 1.

FIG. 4 is a perspective view of another embodiment of the overhead door bracket similar to that of FIG. 1.

FIG. 5 is a plan view of a flat stamping for on-site forming of the overhead door bracket of FIG. 4. Existing brackets have a relatively small mounting flange for mounting on wooden doors by means of screws. Existing brackets attached to sheet metal doors by screws are subject to separation from the door panels due to the thin, unsupported nature of the sheet metal.

Similar reference characters denote corresponding features consistently throughout the attached drawings.

### DETAILED DESCRIPTION OF THE PREFERRED EMBODIMENTS

The present invention is a bracket for attachment of an overhead door opener to a metal overhead door for the purpose of opening and closing the door. Existing brackets have a relatively small mounting flange for mounting on wooden doors by means of screws. Existing brackets attached to sheet metal doors by screws are subject to separation from the door panels due to the thin, unsupported nature of the sheet metal. The inventive bracket has a relatively wide mounting plate which spans the distance between the portions of the sheet metal doors having existing reinforcing backing strips for mounting of the hinges connecting the metal panels of the door.

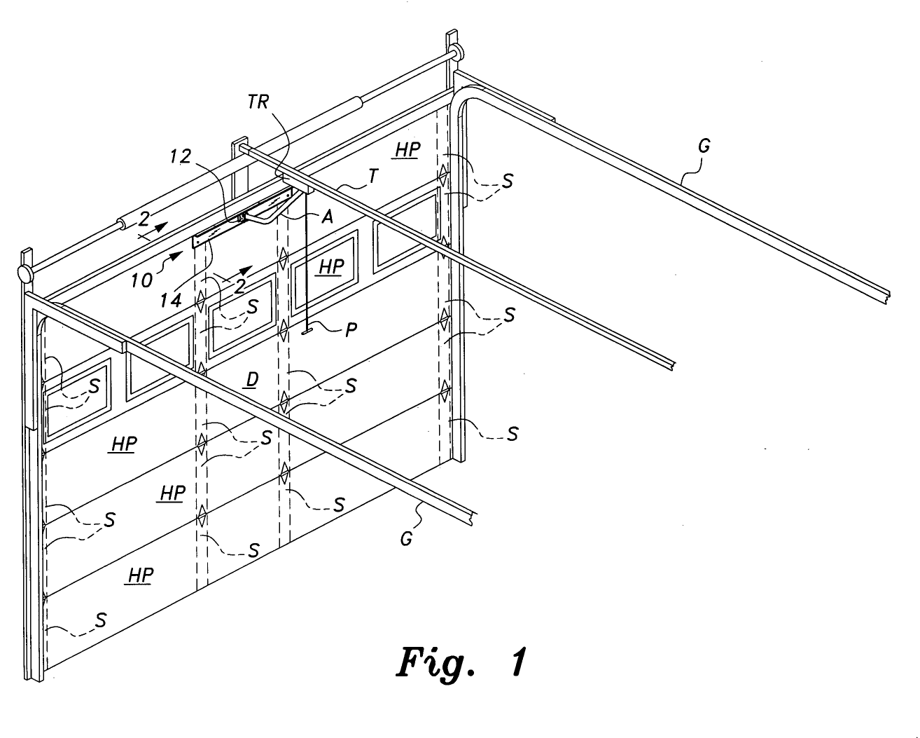

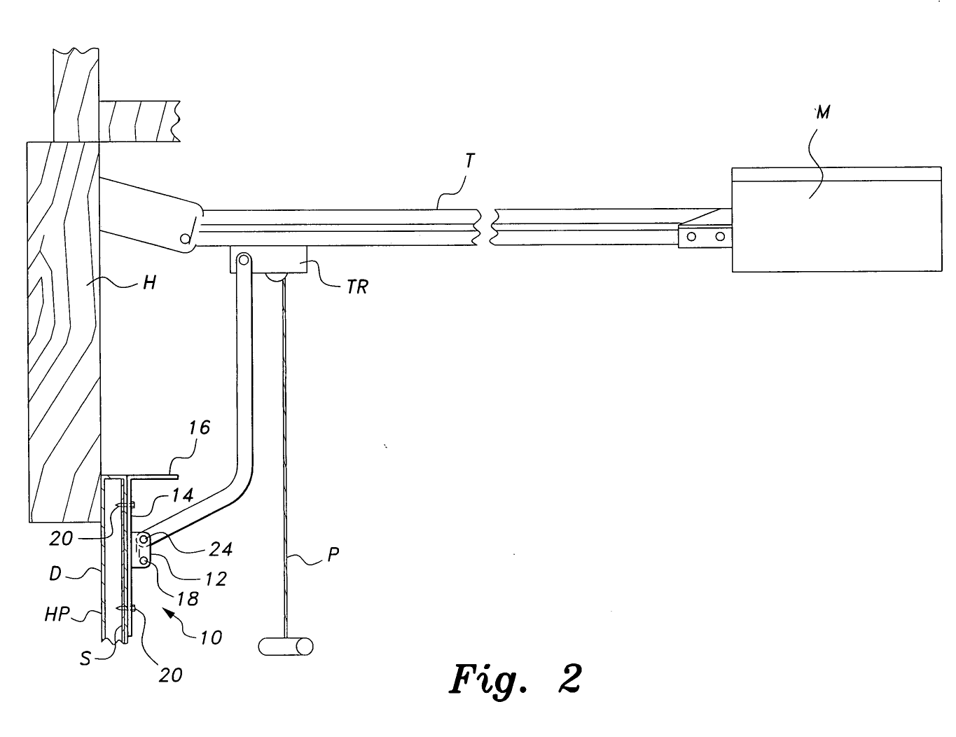

Referring to FIGS. 1 and 2 there is shown an environmental perspective and an environmental sectional view of the overhead door bracket of the present invention referred to herein by the reference No. 10. Door bracket 10 is mounted on an overhead door D made up of horizontal hinged metal panels HP having rollers at opposite sides (not shown) which travel on roller guides G located in the upper interior of a building in a well-known configuration. The bracket 10 is attached to the upper central portion of the uppermost of panels HP.

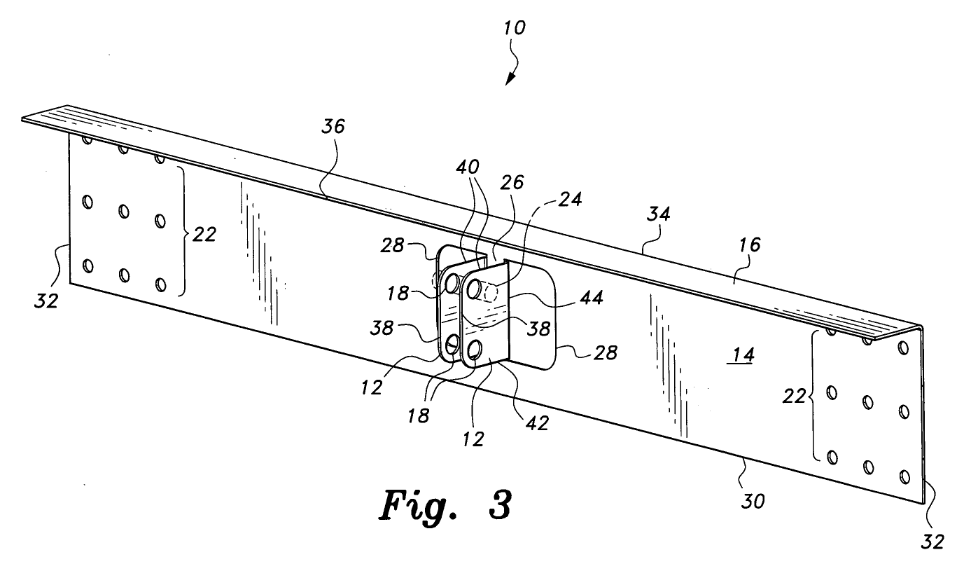

Bracket 10 has a pair of connecting tabs 12, extending outward from a generally planar mounting plate 14 shown as rectangular in shape. Mounting plate 14 has a stiffener 16 formed along its upper edge and has a plurality of mounting holes 22 (see FIG. 3) proximate end portions 32 for mounting with screws 20 such as self-tapping sheet metal screws. Connecting tabs 12 extend outward from mounting plate 14 as attached to hinged panel HP to receive the lower end of main arm A of the door opening and closing system. Main arm A is attached at a lower end between one of two sets of pin receiver bores 18 in tabs 12 by means of a pin (see FIG. 3) extending through the lower end of main arm A and is connected at its upper end to a truck TR which moves along track T powered by motor M in a well known manner. Pull rope P is connected to truck TR for manually opening overhead door D.

Hinged panel HP is made of sheet metal such as sheet steel or aluminum of from about 27 gauge to about 20 gauge in thickness. The hinged panel HP has backing strips S, typically about 3½ inches in width, attached to the inside of the sidewall of the panel HP facing the interior of the garage and extending vertically from the upper edge. to the lower edge of the panel HP at locations where interconnecting hinges are mounted by screws or the like. The backing strips S are typically made of from about 14 gauge to 12 gauge steel sheet and are mounted to the sheet metal of panel HP by adhesive or mechanical means.

Referring to FIG. 3, there is shown a perspective view of one embodiment of the invention wherein door bracket 10 has two spaced, generally rectangular parallel connecting tabs 12 extending outward from the central portion of mounting plate 14. Mounting plate 14 is rectangular planar sheet metal having a mount stiffener 16 extending outward therefrom along upper end 34 and having front edge 36. Connecting tabs 12 each have two vertically spaced pin receiving bores 18 mutually aligned for selectively receiving a pin 24 to secure the lower end of main arm A (See FIG. 2), depending on the length and disposition of a particular arm A as installed (see FIG. 1). Mounting plate 14 forms connecting tab spacer 26 of at least the width of main arm A, determining the spacing of tabs 12 for receiving the main arm A.

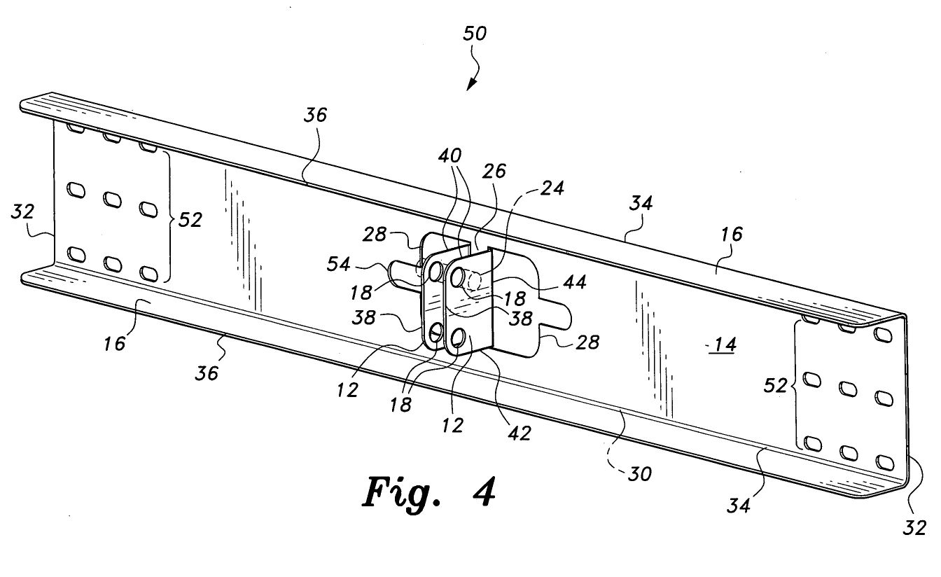

Connecting tabs 12 are generally rectangular in form having outer vertical edges 38 and horizontal upper and lower edges 40 and 42, respectively. Overhead door bracket 10 is preferably unitary in construction, connecting tabs 12 are preferably cut from the sheet material of mounting plate 14 and bent outward along rear bends 44 forming connecting tab voids 28 therein. Alternatively, connecting tabs 12 may be separately attached to mounting plate 14 by welding or mechanical means (not shown). Mounting plate 14 has a lower edge 30 extending between ends 32. Mounting plate 14 may be provided in varied lengths to bridge the gap between backing strips S for different doors. For greater widths, an additional stiffener 36 may be fashioned along lower edge 30 (see FIG. 4) to prevent bending and partial separation of the bracket 10 from the panel HP.

Mounting holes 22 are provided proximate the ends 32 of bracket 10 and preferably form at least three vertical rows, allowing the fitting of a single width of bracket 10 to be mounted on doors having differing spacing between backing strips S within a range (see FIGS. 1 and 2). The mounting holes 22 may be round, or laterally elongated for fine adjustment (see mounting holes 52 of FIG. 4.) and mounting is made by self-tapping screws (not shown) in a conventional manner.

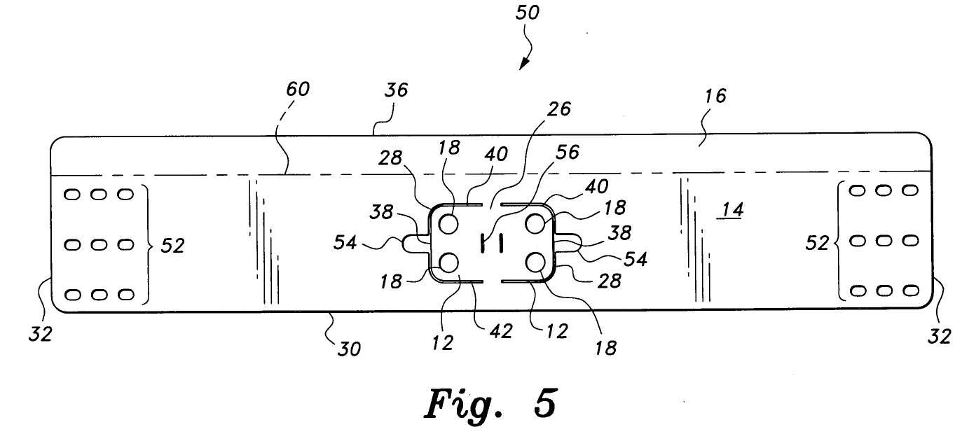

Referring to FIGS. 4 and 5, there is shown another embodiment of the inventive overhead door bracket referred to by element No. 50. Bracket 50 is similar to bracket 10 as discussed above, however bracket 50 may be provided in sheet form (FIG. 5) for bending at the job site to minimize storage space and ease handling. To this end, tabs 12 are cut from voids 28 in mounting plate 14 by a stamping process or the like. Access apertures 54 are cut from mounting plate 14, allowing easy access for the user to grasp tabs 12 and bend them outward for use. Bending guide punches 56 facilitate the accurate bending outward of tabs 12. A line may be scored for bending to form stiffener 16. Laterally elongated mounting holes 52 allow for fine width adjustment for the mounting of screws at backing strips S as described above. Bracket 10 may optionally include an additional stiffener 16 formed at the lower edge 30 of mounting plate 14 which may be bent outward to an angle of from about 30° to about 90° (as shown) from the mounting plate 14.

The bracket of the present invention may be made in widths from 10″ to 120″ and in vertical heights of from 2″ to 24″, depending on the application. As an example, a bracket may have and overall width of 26.0″ and a height of 4.0″ with three rows of mounting slots having centers spaced about 0.5″, 1.25″, and 2.0″, respectively from each end. The stiffener extends about 1.0″ outward from the mounting plate face. The connecting tabs are about 2.75″ in height, extend outward about 2.75″ from the mounting plate face, and are separated by about 0.75″. The thickness of the sheet stock of the bracket is from about 18 gauge to about 10 gauge. The pin receiver bores in the connecting tabs are about 0.375″ in diameter. Corners are radiused for appearance and to avoid snags. The stiffeners are preferably bent from the mounting plate face outward, the upper stiffener at an angle of about 90°, and the lower stiffener at an angle of about 30° to about 90°.

It is to be understood that the present invention is not limited to the embodiments described above, but encompasses any and all embodiments within the scope of the following claims.

I claim:

1. An overhead door bracket for a metal overhead door having vertical backing strips, comprising:
a generally rectangular, horizontally disposed mounting plate having a central portion, opposite end portions laterally spaced from said central portion, an upper edge, and a lower edge; and
a pair of spaced, vertically disposed connecting tabs extending outward from said central portion of said mounting plate and defining corresponding pin receiver bores for laterally receiving a main arm pin;
said connecting tabs being spaced a distance to receive the lower end of the main arm of a door opening system for connection by the main arm pin;
said generally rectangular mounting plate defining at least one mounting hole at each of said end portions; and
said mounting plate being of such a width and said end portions being spaced such that said mounting holes are disposed over a respective pair of backing strips for mounting by fasteners.

2. The bracket of claim 1, each of said connecting tabs defining a pair of mutually aligned, vertically spaced pin receiver bores.

3. The bracket of claim 1, further comprising a first laterally disposed stiffener extending outward from said upper edge of said mounting plate for the substantial length thereof.

4. The bracket of claim 3, further comprising a second stiffener extending outward from said lower edge of said mounting plate for the substantial length thereof, at an angle of from about 30° to about 90°.

5. The bracket of claim 1, said generally rectangular mounting plate defining a plurality of mounting holes at each of said end portions.

6. The bracket of claim 5, said generally rectangular mounting plate defining three vertical rows of mounting holes, each said row having three spaced mounting holes at each of said end portions.

7. The bracket of claim 1, each said generally rectangular mounting plate defining laterally elongated mounting holes at each of said end portions for fine lateral adjustment of said bracket relative to the backing strips.

8. The bracket of claim 3, said generally rectangular mounting plate defining a plurality of mounting holes at each of said end portions.

9. The bracket of claim 8, said generally rectangular mounting plate defining three vertical rows of mounting holes, each said row having three spaced mounting holes at each of said end portions.

10. The bracket of claim 3, each said generally rectangular mounting plate defining three vertical rows of mounting holes, each said row having three spaced mounting laterally elongated mounting holes at each of said end portions for fine lateral adjustment of said bracket relative to the backing strips.

11. The bracket of claim 10, wherein said bracket in unitary and said connecting tabs are bent laterally outward at right angle from said mounting plate leaving a corresponding void defined by said mounting plate at the laterally outer side of each said connecting tab.

12. The bracket of claim 11, said mounting plate defining access apertures at opposed lateral sides of said respective voids defined by said mounting plate, said access apertures opening into said voids for access for fingers or tools to bend said connecting tabs outward from said mounting plate.

13. The bracket of claim 12, said spaced connecting tabs defining a vertical spacer therebetween in said mounting plate.

14. The bracket of claim 13, said mounting plate having spaced bending guide punches defining the right angle bends of said connecting tabs.

15. An overhead door bracket for a metal overhead door having vertical backing strips, comprising:
a generally rectangular, horizontally disposed mounting plate having a central portion, opposite end portions laterally spaced from said central portion, an upper edge, and a lower edge;
said mounting plate having a first laterally disposed stiffener extending outward from said upper edge of said mounting plate for the substantial length thereof; and
a pair of spaced, vertically disposed connecting tabs extending outward from said central portion of said mounting plate and defining corresponding pin receiver bores for laterally receiving a main arm pin;
said connecting tabs being spaced a distance to receive the lower end of the main arm of a door opening system for connection by the main arm pin;
each of said connecting tabs defining a pair of mutually aligned, vertically spaced pin receiver bores
said generally rectangular mounting plate defining at least one mounting hole at each of said end portions; and
said mounting plate being of such a width and said end portions being spaced such that said mounting holes are dispose over a respective pair of backing strips for mounting by fasteners.

16. The bracket of claim 15, said generally rectangular mounting plate defining three vertical rows of mounting holes, each said row having three spaced mounting holes at each of said end portions.

17. The bracket of claim 15, each said generally rectangular mounting plate defining three vertical rows of mounting holes, each said row having three spaced mounting laterally elongated mounting holes at each of said end portions for fine lateral adjustment of said bracket relative to the backing strips.

18. An overhead door bracket for a metal overhead door having vertical backing strips, comprising:
a generally rectangular, horizontally disposed mounting plate having a central portion, opposite end portions laterally spaced from said central portion, an upper edge, and a lower edge;
said mounting plate having a first laterally disposed stiffener extending outward from said upper edge of said mounting plate;
said mounting plate having a second stiffener extending outward from said lower edge of said mounting plate for the substantial length thereof at an angle of about 30° to about 90°;
a pair of spaced, vertically disposed connecting tabs extending outward from said central portion of said mounting plate and defining corresponding pin receiver bores for laterally receiving a main arm pin;
said connecting tabs being spaced a distance to receive the lower end of the main arm of a door opening system for connection by the main arm pin;
each of said connecting tabs defining a pair of mutually aligned, vertically spaced pin receiver bores;
said generally rectangular mounting plate defining three vertical rows of mounting holes, each said row having three spaced mounting laterally elongated mounting holes at each of said end portions; and
said mounting plate having a width between about 10 inches and about 120 inches, said connecting tabs being spaced about 0.75 inches, said at least one row of mounting holes being disposed over each of a respective pair of backing strips for mounting by screws.

19. The bracket of claim 18, wherein said bracket is unitary and said connecting tabs are bent laterally outward at a right angle from said mounting plate leaving a corresponding void defined by said mounting plate at the laterally outer side of each said connecting tab.

20. The bracket of claim 19, said mounting plate defining access apertures at opposed lateral sides of said respective voids defined by said mounting plate, said access apertures opening into said voids for access for fingers or tools to bend said connecting tabs outward from said mounting plate.
